(19) United States
(12) Patent Application Publication
(10) Pub. No.: US 2016/0022083 A1
(43) Pub. Date: Jan. 28, 2016

(54) EASY CLEAN GREASE EXTRACTING SIEVE WITH DISPOSABLE CONTAINER

(71) Applicant: Jerald W. Archuleta, Elgin, IL (US)

(72) Inventor: Jerald W. Archuleta, Elgin, IL (US)

(21) Appl. No.: 14/793,646

(22) Filed: Jul. 7, 2015

Related U.S. Application Data
(60) Provisional application No. 62/021,688, filed on Jul. 7, 2014.

(51) Int. Cl. A47J 19/00

(52) U.S. Cl. CPC A47J 19/005

(57) ABSTRACT

A kitchen accessory for separating and draining grease from cooked ground meat, comprising a sieve bottomed container for receiving the cooked meat, a hinged lid and draining the grease into a disposable and lidded paper container.

### CLAIM OF PRIORITY

This patent application claims priority under 35 USC 119 (e) (1) from U.S. Provisional Patent Application Ser. No. 62/021,688 filed Jul. 7, 2014, of common inventorship herewith entitled, “Easy Clean Grease Extracting Sieve With Disposable Container,” which is incorporated herein by reference as though the same were set forth in its entirety.

### FIELD OF THE INVENTION

The present invention pertains to the field of cooking, and more specifically to the field of grease collection tools.

### BACKGROUND OF THE INVENTION

The prior art has put forth several designs for grease collection tools. Among these are:

U.S. Pat. No. 6,672,204 to Mark A. Fiorello describes a press for removing grease from cooked ground meat that includes a main body provided with an upwardly opening cavity for receiving the cooked meat and a front spout, and a lid pivotally connected to the body and provided with a center pressing plate sized to fit into the cavity against the meat. The body and lid are further provided with complimentary left and right handles sized to be squeezed together with the user's left and right hands. Excess grease is pressed out of and removed from the meat by simultaneously squeezing the handles together and pouring the grease from the spout.

U.S. Pat. No. 4,958,557 to Jeffery Fiala describes a rendered fat separator comprising a bowl having a perforated bottom for receiving cooked fatty meat to be compressed by a rotary press threadedly engaged with the bowl. The rotary press has a socket for accepting a driving sprocket provided with flutes and a handle which rotates the driving socket in threaded engagement with engageable means on the inner surface of the bowl.

U.S. Pat. No. 1,007,907 to Adolph E. Yeager describes a vegetable press of simple, cheap, and efficient construction, particularly constructed for household use. As a vegetable press, the invention is admirably adapted for use as a potato masher or as a fruit press for making cider, jells and the like. A plunger barrel is provided with a clamping leg at its front and a supporting leg at its rear and elevated by said legs providing a receptacle receiving space intermediate said legs and the plunger barrel and subjacent table.

None of these prior art references describe the present invention.

### SUMMARY OF THE INVENTION

It is an object of the present invention to provide a countertop kitchen accessory for separating and draining grease from cooked ground beef, leaving the beef in a sieve bottomed container for easy access and draining the grease into a disposable and lidded paper container.

### BRIEF DESCRIPTION OF THE DRAWINGS

FIG. 1 is an illustrative functional side view showing a top lid, an easy disconnect hinge, a sieve screen, a threaded ring, a disposable container, thumb slots and a base component.

FIG. 2 is a prototypical functional side view showing how the top lid presses into a receiving bin to squeeze grease from inserted ground beef.

FIG. 3 is an illustrative close up view of the disposable container showing how the lid is stored under the container until used.

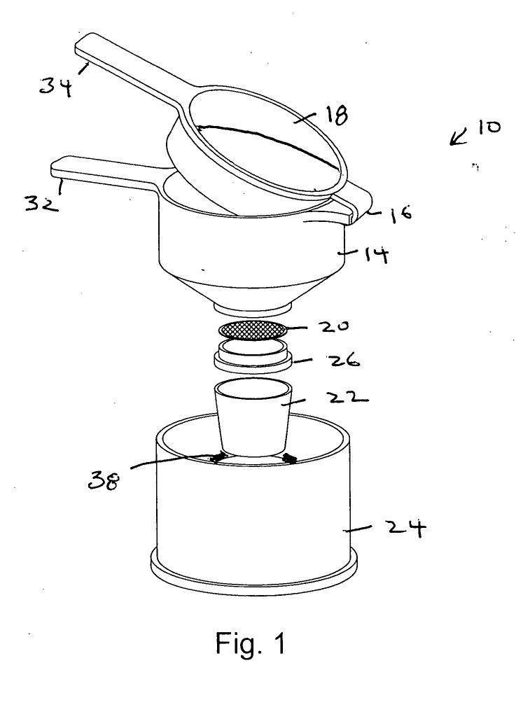

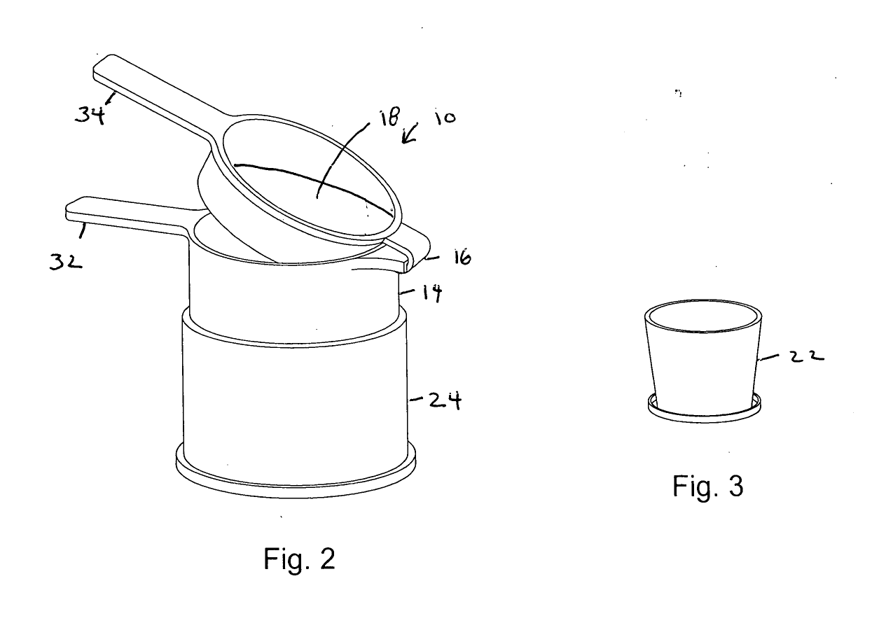

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Dishes such as chili, spaghetti with meat sauce, beef stroganoff, beef tacos and burritos, and hamburger helper are popular dishes in both homes and restaurants. All of these dishes and many more dishes require browning ground beef as an essential ingredient. Browning ground beef requires cooking the beef in a skillet on a stove and then removing the excess grease before incorporating the browned meat in a dish. Most cooks remove the grease by pressing down on the cooked beef with a spatula or pot lid and then pouring the grease out of the skillet into a tin can. Generally in this process, the cook winds up pouring some of the beef into the can along with the grease, along with pouring a substantial quantity of hot grease on the countertop.

The present invention, hereinafter referred to as the Easy Clean Grease Extracting Sieve With Disposable Container or Easy Clean, is a countertop kitchen accessory for separating and draining grease from cooked ground meat such as beef, turkey, pork, venison or buffalo, for example. For purposes of this description, the term “beef” is intended to include any ground meat. The present invention leaves the beef in a sieve bottomed container for easy access and draining the grease into a disposable and lidded paper container. Please refer to the Figures. The Easy Clean Grease Extracting Sieve With Disposable Container 10 comprises a container fabricated in a sturdy and durable molded thermoplastic polymer that is scratch, impact and heat resistant and consists of interlocking components.

The entire device 10 is an essentially circular device having interlocking parts of concentric circular components that rest inside each other, as described below.

The first component is a hinged, twin handled, funnel shaped bin 14 that functions to receive cooked ground beef and grease. Bin 14 has easy disconnect hinge 16 on its edge and hinge 16 connects bin 14 to detachable top lid 18. The bottom of detachable lid 18 extends downward at an angle of approximately sixty degrees into the bin 14. Lid 18 also serves as a press to exert pressure on received cooked beef. Pressing lid 18 onto the beef permits grease to pass through the next component which is a removable sieve or screen 20. Screen 20 is held in a threaded ring 26. Screen 20 is located in the center of the bottom of the bin 14. The solid portion of the ground beef is retained in the bin 14 as the strained grease passes through screen 20 into a paper container 22 which rests in base 24. Screen 20 attaches to the bottom of the bin 14 by means of a threaded ring 26. The bottom of threaded ring 26 rests on top of the paper container 22. The grease is collected in a paper container 22 residing within in the said base. This paper container 22 is equipped with a matching lid and is so constructed for easy, smell free disposal in a trash or garbage can. Paper container 22 rests in the center of base 24.

Once the grease is pressed and strained out of the bin 14 and into the container 22, the bin 14 is removed from the base 24 by a simple pivoting rotation, releasing the detachable hinge 16, and the ground beef is dispensed from the bin 14 for further preparation.

When the container 22 has been removed from the device, all components can be separated and placed into a dishwasher for cleaning, if desired. Paper container 22 rests in base 24 and can be easily removed from the base 24 by use of thumb slots 38. Thumb slots 38 are spaced apart indentations in the container receiving portion of the base 14 to facilitate removal of the container 22 from the base 14.

The Easy Clean is produced in three sizes. A small size accommodates meat consumption for single households. A medium size accommodates meat consumption for families. A large size accommodates meat consumption for commercial and institutional kitchens. Easy Clean holds a minimum of approximately one to two pounds of ground beef. A medium sized Easy Clean measures approximately twelve to thirteen inches in height and length, with approximately three to four inches of this height taken up in the base collection reservoir, and approximately six inches in width. The Easy Clean components are removable for easy cleaning and are dishwasher safe. The commercial and institutional size requires production in aluminum or stainless steel, depending on local and state food service regulations.

The lid of the Easy Clean Grease Extracting Sieve Unit With Disposable Container is easily detachable from the bin by means of a molded, easy disconnect hinge, such that once the grease is strained and removed, the lid is also removable to permit easier handling of the beef. The bin 14 has an extended handle 32, mirrored by the matching handle 34 of the lid 18, which pivots on its hinge 16. A user simply squeezes the two handles together to press downward with the lid and forces the grease out through the sieve and funnel.

The present invention makes separating, collecting and disposing of ground beef grease one simple, efficient operation. Easy Clean eliminates spilling grease on the counter or floor and dumping smelly grease in the garbage. A simple, lidded paper container collects the strained grease on the counter and then keeps the grease contained in the trash can.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device for separating and draining grease from cooked meat, comprising: an essentially circular device having interlocking parts of concentric circular components that rest inside each other, wherein:
the first component is a hinged, twin handled, funnel shaped bin that is capable of receiving cooked ground meat, wherein the bin is circular and has an easy disconnect hinge on its edge, further wherein the hinge connects the bin to a detachable top lid, wherein pressure applied to the top lid onto meat placed in the bin permits grease to pass through a removable sieve or screen, wherein the screen is located in the center of the bottom of the bin, and wherein strained grease passes through the screen into a removable paper container, wherein the paper container rests in a base.

2. The device of claim 1, wherein the screen 20 is held in place by a threaded ring which attaches to the bottom of the bin and rests on top of the paper container.

3. The device of claim 1, further wherein the paper container is equipped with a matching lid for easy, smell free disposal in a trash or garbage can.

4. The device of claim 1 wherein the paper container rests in the center of the base.

5. The device of claim 1 produced in three sizes, wherein a small size accommodates meat consumption for single person households, a medium size accommodates meat consumption for families, and a large size accommodates meat consumption for commercial and institutional kitchens.

6. The device of claim 1 wherein a medium sized device measures approximately twelve to thirteen inches in height, with approximately three to four inches of this height taken up in the base collection reservoir, and approximately six inches in diameter.

7. The device of claim 1, further comprising an extended handle on the bin and a matching handle on the lid, wherein the handles are capable of being pressed together to press the grease from the meat in the bin.

8. The device of claim 1 wherein all components, excluding the paper container, are removable for easy cleaning and are dishwasher safe.

9. The device of claim 1, wherein the device is made of aluminum, stainless steel, or sturdy and durable molded thermoplastic polymer that is scratch, impact and heat resistant, or combinations thereof.

10. The device of claim 1, wherein the bottom of the lid is angled from the hinge to the handle at an angle of approximately with the deepest portion at the handle and the shallowest portion at the hinge.

11. The device of claim 1 wherein the base further comprises indentations to receive the thumbs of a user to facilitate removal of the container from the base.
